(19) United States
(12) Patent Application Publication
(10) Pub. No.: US 2025/0334700 A1
(43) Pub. Date: Oct. 30, 2025

(54) SUSPENSION OF GNSS SIGNAL USAGE DURING WIRELESS SIGNAL INTERFERENCE

(71) Applicant: QUALCOMM Incorporated, San Diego, CA (US)

(72) Inventor: Qutubuddin MOHAMMED, Santa Clara, CA (US)

(21) Appl. No.: 18/412,298

(22) Filed: Jan. 12, 2024

(51) Int. Cl. G01S 19/21; G01S 19/24

(52) U.S. Cl. CPC G01S 19/21; G01S 19/24

(57) ABSTRACT

An example method to mitigate interference in a position determination operation can include obtaining one or more global navigation satellite system (GNSS) signals; identifying a time window associated with a wireless signal transmitted by a wireless transmitter; and performing at least one interference mitigation action based on detecting a drop in signal amplitude of at least one of the one or more GNSS signals during the time window.

### BACKGROUND

### 1. Field of Disclosure

The present disclosure relates generally to the field of position determination based on satellite signals, and more specifically relates to mitigating interference caused by wireless signals when performing position determination operations based on satellite signals.

### 2. Description of Related Art

The use of Global Navigation Satellite Systems (GNSS) signals can provide highly accurate positioning information of a device such as, for example, a smartphone, a navigation aid, a surveying equipment, or an Internet-of-Things (IoT) device. Traditional GNSS positioning provides an accuracy on the order of a few meters and more precise GNSS-based techniques such as, for example, Precise Point Positioning (PPP) and Real Time Kinematic (RTK) can provide more precision. In either case, the accuracy of the positioning information obtained by use of GNSS signals can depend in large part on the performance of the GNSS receiver in the device. In some scenarios, the operation of the GNSS receiver may be adversely affected by radio frequency (RF) interference that may be caused by a wireless transmitter that is either a part of the device or located outside the device.

### BRIEF SUMMARY

An example method to mitigate interference in a position determination operation can include obtaining one or more global navigation satellite system (GNSS) signals; identifying a time window associated with a wireless signal transmitted by a wireless transmitter; and performing at least one interference mitigation action based on detecting a drop in signal amplitude of at least one of the one or more GNSS signals during the time window.

An example device that performs a position determination operation with interference mitigation can include one or more global navigation satellite system (GNSS) receivers and at least one controller. The at least one controller can include at least one memory and one or more processors communicatively coupled with the one or more GNSS receivers and the at least one memory. The one or more processors can be configured to obtain one or more GNSS signals; identify a time window associated with a wireless signal transmitted by a wireless transmitter; and perform at least one interference mitigation action based on detecting a drop in signal amplitude of at least one of the one or more GNSS signals during the time window.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 shows an example system that includes a user equipment having a GNSS receiver in accordance with the disclosure.

FIG. 2 includes a block diagram of various example hardware and software components that may be included in the user equipment illustrated in FIG. 1.

FIG. 3 illustrates some example components that may be included in a GNSS receiver in accordance with an embodiment.

FIG. 4 shows a functional flow of operations for mitigating wireless signal interference in a user equipment in accordance with an embodiment of the disclosure.

FIG. 5 illustrates a first graphical representation for describing an example operation to detect a drop in GNSS signal amplitude in the presence of wireless signal interference in accordance with an embodiment.

FIG. 6 illustrates a second graphical representation for describing an example operation to detect a drop in GNSS signal amplitude in the presence of wireless signal interference in accordance with an embodiment.

FIG. 7 shows a flowchart of a method to mitigate wireless signal interference in a position determination operation in accordance with an embodiment of the disclosure.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, particular features, structures, or characteristics described herein may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the phrase “user equipment” is not intended to be exclusive or limited to any specific implementation described herein, unless otherwise noted. In general, the phrase “user equipment” refers to any device that can perform location determination operations based on GNSS signals. A few non-exhaustive examples can include a smartphone, a mobile phone, a tablet computer, a laptop computer, a tracking device, a wearable device (e.g., smartwatch, glasses, Augmented Reality (AR)/Virtual Reality (VR) headset, etc.), and an Internet of Things (IoT) device. The word “transmitter” as used herein encompasses a transceiver and any description provided herein with reference to a transmitter is equally applicable to a transceiver. The phrase “space vehicle” (SV) or “satellites” as referred to herein, relates to an object that is capable of transmitting signals to receivers on the earth's surface. In one particular example, such an SV may be a geostationary satellite. Alternatively, an SV may be a satellite traveling in an orbit and moving relative to a stationary position on the earth. However, these are merely examples of SVs and claimed subject matter is not limited in these respects. Words such as interference, corruption, disturbance, interruption, and deterioration may be used in an interchangeable manner and generally refers to an undesirable condition.

As described herein, a global navigation satellite system (GNSS) receiver may be included in any of various types of user equipment. Location information determined by the user equipment based on GNSS signals received by the GNSS receiver may be referred to herein as a location estimate, a location fix, a fix, a position, a position estimate or a position fix. In some cases, a location may be described in a geodetic format, thus providing location coordinates for the global positioning system (GPS) receiver (e.g., latitude and longitude) which may or may not include an altitude component (e.g., height above sea level, height above or depth below ground level, floor level or basement level). In some other cases, the location information can include an altitude component such as, for example, when the user equipment is a navigation aid located in an airborne vehicle.

As indicated above, the accuracy of positioning information determined by a user equipment can depend in large part on the performance of a GNSS receiver in the user equipment. Traditional GNSS positioning provides an accuracy on the order of a few meters, and more precise GNSS-based techniques such as Real Time Kinematic (RTK) and Precise Point Positioning (PPP) can provide sub-meter accuracy. Both techniques use additional correction information to achieve the higher level of accuracy. However, traditional positioning determination techniques performed with, or without, additional correction, may fail to take into consideration certain technical problems associated with operating environments and physical features of a user equipment.

One example technical problem involves interference, corruption, disturbance, interruption, and//or deterioration of a GNSS signal received by the GNSS receiver. Interference, corruption, disturbance, interruption, and/or deterioration of the GNSS signal can occur when the user equipment is located in certain places such as, for example, in an enclosed garage, an underground parking space, or amidst tall buildings in an urban area. For example, a GNSS signal can be corrupted due to radio-frequency interference (RFI) generated by various sources and/or due to non-GNSS wireless signals being present inside a GNSS band being used by the GNSS receiver. Corruption of the GNSS signal can cause issues such as, for example, a momentary loss of positioning information, a delay in obtaining positioning information, or in extreme cases, generation of erroneous positioning information.

The non-GNSS wireless signals causing the signal corruption/interference may be transmitted by various sources that may be either located outside the user equipment in some cases or co-located along with a GNSS receiver inside the user equipment in some other cases. In an example scenario, a user equipment that includes a GNSS receiver may also include a wireless transmitter that is used for transmitting RF signals to a wireless receiver located outside the user equipment. The wireless transmitter and wireless receiver may be a part of any of various systems such as, for example, a wireless wide-area network (WWAN) system, an ultra-wideband (UWB) system, or a voice communication system (cellular phone, for example). One or more frequencies of the wireless transmitter may operate inside a GNSS band being used by a GNSS receiver provided in the user equipment and may cause interference upon GNSS signals received by the GNSS receiver.

Accordingly, a technical solution to address the technical problem described above is provided herein. More particularly, a position determination procedure in accordance with the disclosure can include identifying a time window during which a GNSS receiver can be vulnerable to signal interference attributable to a wireless signal transmitted by a wireless transmitter. The signal interference may occur when a GNSS signal is being used for obtaining positioning information of a user equipment.

In an example embodiment, information about the time window may be provided by a wireless transmitter that transmits a wireless signal that can cause the signal interference. The information may be provided in various forms such as, for example, in the form of messages and/or in the form of digital pulses.

The signal interference may manifest itself as a drop in signal amplitude of a GNSS signal in a GNSS receiver of the user equipment. The drop in signal amplitude can be detected based on monitoring an input terminal and/or an output terminal of one or more components of the GNSS receiver over the time window when the signal interference can be expected to occur. The components of the GNSS receiver may include, for example, an amplifier that is configured to amplify the GNSS signal and/or an analog-to-digital converter (ADC). One or more interference mitigation procedures can be performed based on determining that the drop in amplitude of the GNSS signal in the GNSS receiver is greater than a signal drop detection threshold.

In an example implementation, an interference mitigation procedure can include disregarding position information determined during the drop in signal amplitude of the GNSS signal below the signal drop detection threshold. An amount, frequency, and/or efficiency of frequency of interference mitigation may be varied based on using a settable signal drop detection threshold in accordance with disclosure.

In another example implementation, an interference mitigation procedure can include disregarding a GNSS signal that is being received from a first GNSS satellite (or is expected to be received from the first GNSS satellite) over a time window provided by a wireless transmitter and using a GNSS signal received from a second GNSS satellite for obtaining position information over the time window. The first GNSS satellite may be a part of a first GNSS system (a global positioning satellite (GPS) system, for example) and the second GNSS satellite can belong to a second GNSS system a Global Navigation Satellite System (GLONASS), for example).

In yet another example implementation, a wireless transmitter that is transmitting the wireless signal causing interference may be instructed to modify an operation of the wireless transmitter such as, for example, stop transmitting during the time window and/or change a transmission frequency so as to avoid signal interference.

At least one technical advantage that is provided in accordance with the disclosure pertains to determining that a signal interference signal is caused by a specific wireless transmitter over a specific time window, unlike in a traditional system that merely detects an error in the results of a location determination procedure due to signal interference from one or more wireless transmitters at non-specific times.

Another technical advantage pertains to optimizing and minimizing an amount of interference mitigation actions that can be performed when performing a position determination operation based on GNSS signals. More particularly, interference mitigation actions can be carried out over relatively short periods of time when the drop in signal amplitude of the GNSS signal below the signal drop detection threshold is detected, rather than over an entire time window when signal interference can be expected to occur (such as, for example, over an entire time window when one or more frequencies of a non-GNSS wireless signal overlaps a GNSN band that is being used for position determination by a user equipment).

The number of times when interference mitigation actions are taken and/or a rate at which interference mitigation actions are taken can be tailored to various performance requirements based on selecting a suitable signal drop detection threshold. Thus, for example, a first number of times when interference mitigation actions are taken based on a first signal drop detection threshold can be different than a second number of times when interference mitigation actions are taken based on a second signal drop detection threshold. The first number of times can be lower than the second number of times when the first signal drop detection threshold is set at a greater level than the second signal drop detection threshold. The first number of times can reflect a first level of mitigation efficiency and the second number of times can reflect a second level of mitigation efficiency. Additional details pertaining to these aspects and other aspects of the disclosure are described below.

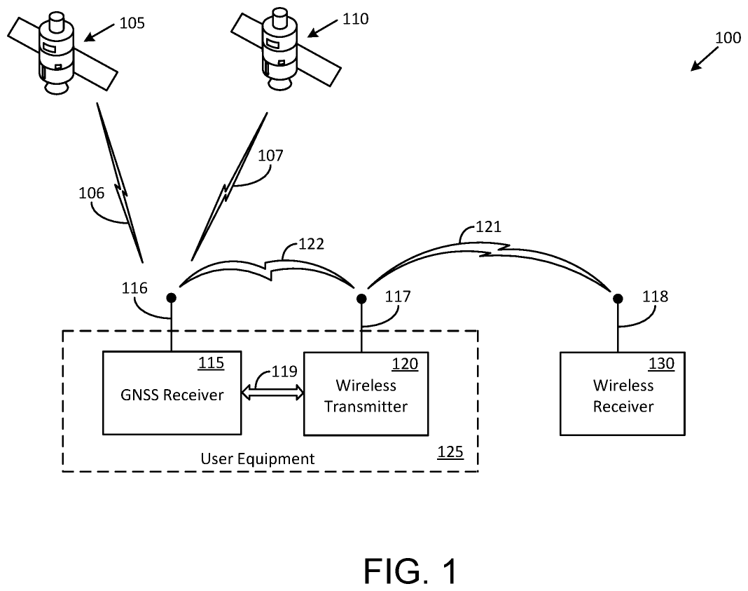

FIG. 1 shows an example system 100 that includes a user equipment 125 having a GNSS receiver 115 in accordance with the disclosure. In this example, the user equipment 125 further includes a wireless transmitter 120 that is configured to communicate with a wireless receiver 130 located outside the user equipment 125. In another example, both the wireless transmitter 120 and the wireless receiver 130 can be located outside the user equipment 125.

The wireless transmitter 120 and the wireless receiver 130 can be components of any of various systems. A non-comprehensive list of such systems can include a wireless wide-area network (WWAN) system, an ultra-wide band (UWB) system, a radio-frequency (RF) detector/sniffer system, an RF communication system, and a Wi-Fi system. The wireless transmitter 120 may be configured to communicate with the wireless receiver 130 via any one or more of different types of networks such as, for example, a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network.

The wireless transmitter 120 may transmit one or more wireless signals containing one or more frequencies that overlap one or more GNSS frequency bands used by the GNSS receiver 115 for determining a position of the user equipment 125. The GNSS frequency bands can include various L bands used by any of various satellite vehicles (SVs) of any of various GNSS constellations (e.g., Global Position System (GPS), Galileo (GAL), Global Navigation Satellite System (GLONASS), Beidou, etc.).

In the illustrated example, the GNSS receiver 115 is coupled to an antenna 116 that is arranged to receive a GNSS signal from one or both of a first SV 105 and a second SV 110. In some cases, two separate antennas can be used for receiving GNSS signals, such as, for example, a first antenna tuned to receive GNSS signals 106 from the first SV 105 (which could belong to a GPS satellite system) and a second antenna tuned to receive GNSS signals 107 from the second SV 110 (which could belong to a GLONASS system). In an embodiment, the antenna 116 may be configured to receive a first type of GNSS signal that is known in the art as an L1 signal (1575.42 MHz) and/or to receive a second type of GNSS signal that is known in the art as an L5 signal (1176.45 MHz).

The wireless transmitter 120 is coupled to an antenna 117 that is configured for transmitting a wireless signal to the wireless receiver 130. A first portion 121 of the wireless signal transmitted by the wireless transmitter 120 can be received in an antenna 118 of the wireless receiver 130. Another portion 122 of the wireless signal may be received in the antenna 116 of the GNSS receiver 115 and may cause signal interference. The signal interference caused by the portion 122 of the wireless signal can be mitigated by using an interference mitigation procedure in accordance with the disclosure. In an example embodiment, an interference mitigation procedure can involve the GNSS receiver 115 receiving from the wireless transmitter 120, information about a time window during which the signal interference may occur. A communication link, such as, for example, a bus 119, may be used for communications between the GNSS receiver 115 and the wireless transmitter 120 for executing the transfer of this information from the wireless transmitter 120 to the GNSS receiver 115.

It will be understood that the diagram provided in FIG. 1 is greatly simplified. In practice, there may be dozens of satellites in a GNSS system, and there are many different types of GNSS systems. Some examples of GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to a basic positioning functionality that provides a certain degree of accuracy, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

A GNSS positioning procedure is typically based on trilateration/multilateration, which is a method of determining position by measuring distances to points at known coordinates. In general, the determination of the position of the GNSS receiver 115 in three dimensions may rely on a determination of the distance between the GNSS receiver 115 and four or more satellite vehicles. Three-dimensional (3D) coordinates may be based on a coordinate system (e.g., XYZ coordinates; latitude, longitude, and altitude; etc.) centered at the earth's center of mass. A distance between each satellite vehicle and the GNSS receiver 115 may be determined using precise measurements made by the GNSS receiver 115 of a difference in time from when a RF signal is transmitted from the respective satellite vehicle to when it is received at the GNSS receiver 115. To help ensure accuracy, not only does the GNSS receiver 115 need to make an accurate determination of when the respective signal from each satellite vehicle is received, but many additional factors need to be considered and accounted for. These factors include, for example, clock differences at the GNSS receiver 115 and satellite vehicle (e.g., clock bias), a precise location of each satellite vehicle at the time of transmission (e.g., as determined by the broadcast ephemeris), the impact of atmospheric distortion (e.g., ionospheric and tropospheric delays), and the like.

To perform a traditional GNSS position fix, the GNSS receiver 115 can use code-based positioning to determine its distance to each satellite vehicle based on a determined delay in a generated pseudorandom binary sequence received in the RF signals received from each satellite, in consideration of the additional factors and error sources previously noted. With the distance and location information of the satellite vehicles, the GNSS receiver 115 can then determine a position fix for its location. This position fix may be determined, for example, by a Standalone Positioning Engine (SPE) executed by one or more processors of the GNSS receiver 115. However, code-based positioning is relatively inaccurate and, without error correction, is subject to errors. Even so, code-based GNSS positioning can provide a positioning accuracy for the GNSS receiver 115 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellite vehicles observed by the GNSS receiver 115 can be mitigated or canceled based on similar carrier-based ranging of the satellite vehicles using a highly accurate GNSS receiver at the base station at a known location. These measurements and the base station's location can be provided to the GNSS receiver 115 for error correction. This position fix may be determined, for example, by a Precise Positioning Engine (PPE) executed by one or more processors of the GNSS receiver 115. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters). (An SPE and/or PPE may be referred to herein as a GNSS positioning engine, and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. One or more of the satellite vehicles may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, the GNSS receiver 115 may use separate receive chains for different frequency bands. As another example, the GNSS receiver 115 may use a common receive chain for multiple frequency bands that are close in frequency, for example L2 and L5 bands. As another example, the GNSS receiver 115 may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

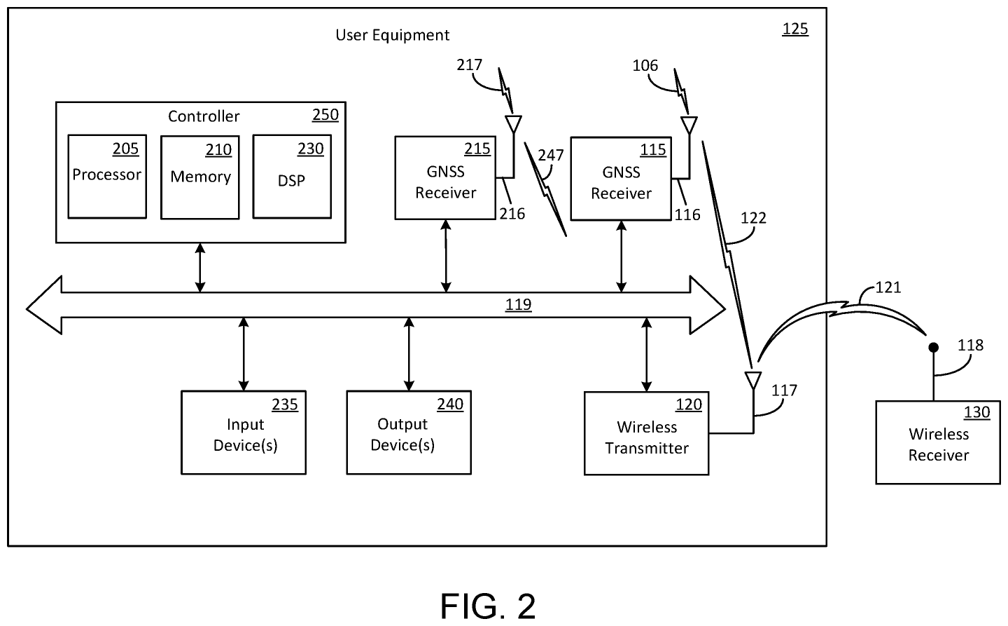

FIG. 2 includes a block diagram of various hardware components of the user equipment 125 according to an embodiment. It should be noted that FIG. 2 is meant only to provide a generalized illustration of various components, any or all of which may be utilized as appropriate. The user equipment 125 may vary in form and function, and may ultimately comprise any device that can perform location determination based on GNSS signals. A few non-exhaustive list of such devices can include, for example, a smartphone, a mobile phone, a tablet computer, a laptop computer, a tracking device, a wearable device (e.g., smartwatch, glasses, Augmented Reality (AR)/Virtual Reality (VR) headset, etc.), an Internet of Things (IoT) device, a navigation device in a vehicle, and survey equipment. Thus, in some instances, components illustrated by FIG. 2 can be localized to a single physical device and/or distributed among various networked devices, which may be disposed at different physical locations (e.g., different locations on a vehicle).

Furthermore, the types of user equipment 125 may vary, depending on application. In some embodiments, for instance, the user equipment 125 may be consumer electronics or devices, such as a smartphone, a mobile phone, tablet, laptop, wearable device, vehicle, or the like. In some embodiments, the user equipment 125 may comprise industrial equipment, such as survey equipment. In yet other embodiments, the user equipment 125 can be integrated with equipment to provide various location-based functionalities, such as being integrated in vehicles, including autonomous ground, aerial, and maritime vehicles.

The user equipment 125 is shown as including various hardware elements that can be electrically coupled via the bus 119 (or may otherwise be in communication, as appropriate). The hardware elements may include one or more processors, which can include without limitation one or more general-purpose processors, one or more special-purpose processors (such as DSP chips, graphics processors (GPUs), application specific integrated circuits (ASICs), and/or the like), and/or other processor, processing structure, processing unit, or processing means. An example processor 205 is shown in FIG. 2. Some embodiments may have a separate DSP 230, depending on desired functionality. Location determination and interference mitigation during location determination may be performed by the processor 205 in cooperation with various other components coupled to the bus 119. The hardware elements may also include one or more memories, such as, for example, the memory 210 shown in FIG. 2. The processor 205 can communicate with the memory 210 and access software and/or firmware code stored in the memory 210 for executing various operations in accordance with the disclosure. In the illustrated example implementation, the processor 205, the memory 210, and the DSP 230 are components included in a controller 250. The controller 250 can include several other components that are not shown.

The user equipment 125 can further include one or more input devices 235, which can include without limitation a keyboard, touch screen, a touch pad, microphone, button(s), dial(s), switch(es), and/or the like; and one or more output devices 240, which can include without limitation a display, light emitting diode (LED), speakers, and/or the like. As will be appreciated, the type of input devices 235 and output devices 240 may depend on the type of user equipment 125 with which the input devices 235 and output devices 240 are integrated.

In the illustrated example embodiment, the user equipment 125 includes two GNSS receivers—the GNSS receiver 115 described above and another GNSS receiver 215. In other embodiments, the user equipment 125 can include a single GNSS receiver or more than two GNSS receivers. In this example, the GNSS receiver 115 may be configured to receive the GNSS signal 106 from the satellite vehicle 105 as shown in FIG. 1. The GNSS receiver 215 may be configured to receive a GNSS signal 217 from a satellite vehicle other than the satellite vehicle 105, such as, for example, to receive the GNSS signal 107 from the satellite vehicle 110 shown in FIG. 1.

The user equipment 125 may also include the wireless transmitter 120 described above. As described above, the wireless transmitter 120 includes an antenna 117 that is configured for transmitting a wireless signal to the wireless receiver 130. The first portion 121 of the wireless signal transmitted by the wireless transmitter 120 can be received by the antenna 118 of the wireless receiver 130. A second portion 122 of the wireless signal may be received by the antenna 116 of the GNSS receiver 115 and cause signal interference. The signal interference caused by the second portion 122 of the wireless signal can be mitigated by using an interference mitigation procedure in accordance with the disclosure. In an example embodiment, an interference mitigation procedure can involve the GNSS receiver 115 receiving from the wireless transmitter 120, information about a time window during which the signal interference may occur. The information may be conveyed to the GNSS receiver 115 via the bus 119. Further details pertaining to the interference mitigation procedure are provided below.

A third portion 247 of the wireless signal transmitted by the wireless transmitter 120 may be received in the antenna 216 of the GNSS receiver 215 and cause signal interference. The signal interference caused by the third portion 247 of the wireless signal can be mitigated by using an interference mitigation procedure in accordance with the disclosure. In an example embodiment, an interference mitigation procedure can involve the GNSS receiver 215 receiving from the wireless transmitter 120, information about a time window during which the signal interference may occur. The information may be conveyed to the GNSS receiver 215 via the bus 119. Further details pertaining to the interference mitigation procedure are provided below.

It can be noted that, although GNSS receiver 115 and GNSS receiver 215 illustrated in FIG. 2 are illustrated as components distinct from other components within the user equipment 125, embodiments are not so limited. As used herein, the term “GNSS receiver” may comprise hardware and/or software components configured to obtain GNSS measurements (measurements from GNSS satellites). In some embodiments, therefore, the GNSS receiver may comprise a positioning engine executed (as software) by one or more processors, such as the processor 205 and/or the DSP 230.

The memory 210 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 210 of the user equipment 125 also can comprise software elements (not shown in FIG. 2), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 210 that are executable by the processor 205 and/or DSP 230 within the user equipment 125.

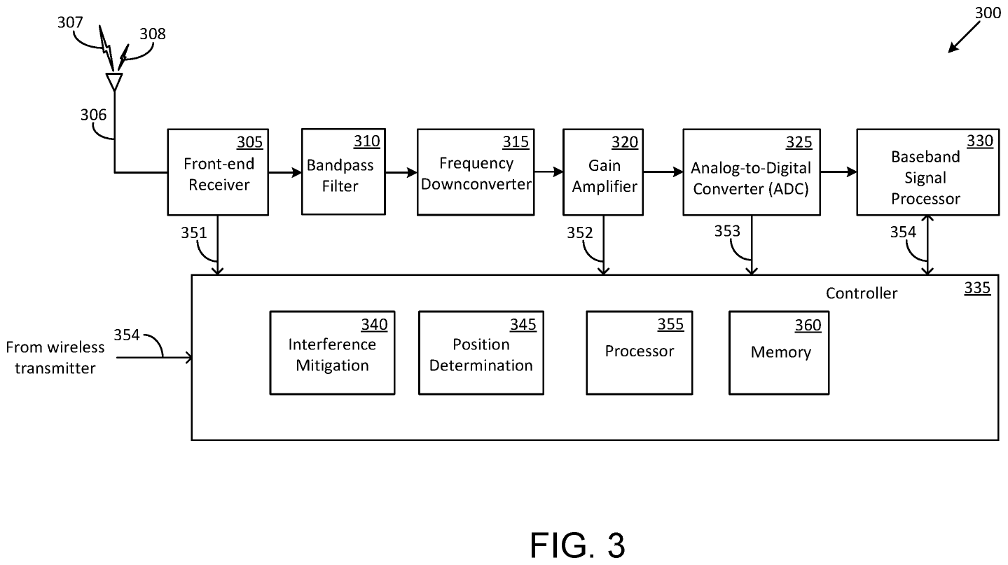

FIG. 3 illustrates some example components that may be included in a GNSS receiver 300 in accordance with an embodiment. The GNSS receiver 300 can be, for example, the GNSS receiver 115 or the GNSS receiver 215 described above. The example components can include a front-end receiver 305, a bandpass filter 310, a frequency downconverter 315, a gain amplifier 320, an analog-to-digital converter (ADC) 325, a baseband signal processor 330, and a controller 335. It must be understood that the GNSS receiver 300 is illustrated in a simplified functional block format and that there can be several other components performing various other functionalities that are not described herein. For example, the GNSS receiver 300 can include one or more oscillators (a local oscillator for frequency down conversion, for example), automatic gain control (AGC) circuitry for controlling signal gain, one or more sensors for detecting one or more signal amplitudes at various locations (power sensor, current sensor, etc.), bus drivers, a power supply, and a digital signal processor (DSP).

The controller 335 can include hardware, firmware, software, and/or combinations thereof, for performing various operations in accordance with the disclosure. In this example implementation, the hardware can include a processor 355 that is coupled with a memory 360 for performing various functions in accordance with the disclosure. Two example functions in the form of position determination 345 and interference mitigation 340 are shown. In another implementation, the controller 335 may be omitted in the GNSS receiver 300 and the controller 250 shown in FIG. 2 may be used instead.

The front-end receiver 305 can include components such as, for example, an RF transformer, a low-noise pre-amplifier, one or more RF filters, and a front-end gain amplifier. The RF transformer may be selected to provide impedance matching between the low-noise pre-amplifier and an antenna 306 that is configured to receive one or more GNSS signals from one or more GNSS satellites such as for example, a GNSS signal 307. A wireless interference signal 308 may also be received by the antenna 306. The wireless interference signal 308 can be for example, the portion 122 of the wireless signal transmitted by the wireless transmitter 120 described above, and/or a GNSS signal that is not used by the user equipment 125.

When the wireless interference signal 308 is not present, the GNSS receiver 300 operates upon the GNSS signal 307 without performing interference mitigation 340 during position determination 345. When the wireless interference signal 308 is present, the GNSS receiver 300 performs interference mitigation 340 during position determination 345. Interference mitigation 340 in accordance with the disclosure can include monitoring GNSS signal amplitudes at the input terminals and/or output terminals of various components, including, for example, a signal amplifier of the front-end receiver 305. The signal amplifier of the front-end receiver 305 can be a low-noise pre-amplifier and/or a front-end gain amplifier. The GNSS signal amplitudes monitored and detected at the input terminals and/or output terminals of the component(s) of the front-end receiver 305 can be conveyed to the controller 335 via a communications link 351. In an example implementation, the communications link 351 (and other communication links shown in FIG. 3) can be implemented in the form of a bus.

The bandpass filter 310 is configured to pass signals of frequencies within a desired frequency range, e.g., the L1 band, with little if any attenuation, and to significantly attenuate signals of frequencies outside the desired frequency band of the bandpass filter 310.

A frequency downconverter 315 provides frequency down conversion of the GNSS signal that is received by the antenna 306 and propagated through the bandpass filter 310. The frequency down conversion is typically carried out by using a phase-lock loop (PLL) circuit that includes a frequency mixer and a local oscillator. The down-converted frequency, which can be an intermediate frequency (IF) or a baseband frequency, can be operated upon by the controller 335 to obtain information such as, for example, position information. In the illustrated implementation, an input terminal of the frequency downconverter 315 is shown coupled to an output of the bandpass filter 310. In another implementation, the frequency downconverter 315 may be incorporated inside the front-end receiver 305, and the bandpass filter 310 can be configured to propagate signals at IF frequencies or baseband frequencies while blocking other signals.

Gain amplifier 320 can be implemented in the form of any of various types of components. In an example implementation, gain amplifier 320 is a programmable gain amplifier (PGA) that provides signal gain based on gain factors that can be programmably set by the controller 335 using digital signals. In another example implementation, gain amplifier 320 is an RF power amplifier having a preset gain factor. The GNSS signal amplitudes monitored and detected at the input terminals and/or output terminals of the gain amplifier 320 can be conveyed to the controller 335 via a communications link 352.

The analog-to-digital converter (ADC) 325 digitizes an analog signal output of the gain amplifier 320. The digitized output of the ADC 325 is coupled into the baseband signal processor 330 and can be monitored by the controller 335 (via a communications link 353).

The baseband signal processor 330 can be configured to cooperate with the controller 335 for performing various functions of the user equipment 125. In an example implementation, the baseband signal processor 330 may cooperate with the controller 335 to provide a modem function. In another example implementation, the baseband signal processor 330 may cooperate with the controller 335 to provide position determination 345. Position determination 345 can include operations such as analyzing GNSS signal information to determine parameters such as, for example, pseudo-range, carrier-to-noise-density ratio, and Doppler, carrier phase. Position determination 345 can further include determining a position of the user equipment 125 based on processing the GNSS signal 307.

The GNSS signal 307 may be received from any of various GNSS satellite vehicles such as, for example, GPS, GAL, Global Navigation Satellite System (GLONASS), Quasi-Zenith Satellite System (QZSS) over Japan, Indian Regional Navigational Satellite System (IRNSS) over India, Beidou Navigation Satellite System (BDS) over China, and/or the like. The GNSS receiver 300 may also be used with various augmentation systems (e.g., Satellite-based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like. Some other aspects associated with position determination 345 have been described above with reference to FIG. 1.

Interference mitigation 340, which is described below in more detail, pertains to mitigating adverse effects of the wireless interference signal 308 upon the operation of the GNSS receiver 300. More particularly, interference mitigation 340 can be directed at ensuring that position determination 345 operates in accordance with a desired level of accuracy and reliability. An example method to mitigate interference in position determination 345 may be carried out by executing a “de-sensing” operation upon the GNSS receiver 300 when wireless signal interference takes place.

In an example scenario, a “de-sensing” operation may be carried out based on detecting a signal amplitude drop in the front-end receiver 305 and/or in the gain amplifier 320 due to the wireless interference signal 308 being present inside one or more GNSS frequency bands of the GNSS signal 307 that is being used by the GNSS receiver 300 for position determination 345. The one or more GNSS frequency bands can include various L bands used by any of various satellite vehicles (SVs) of any of various GNSS constellations (e.g., Global Position System (GPS), Galileo (GAL), Global Navigation Satellite System (GLONASS), Beidou, etc.). The wireless interference signal 308 can be a wireless signal transmitted by a transmitter of any of various systems such as, for example, a wireless wide-area network (WWAN) system, an ultra-wideband (UWB) system, or a voice communication system (cellular phone, for example).

The drop in signal amplitude may occur in the gain amplifier 320, for various reasons. In one example, the drop in signal amplitude may occur due to an automatic gain control (AGC) action that takes place in response to an input signal overload into the gain amplifier 320. The input signal overload may occur as a result of the wireless interference signal 308 combining with the GNSS signal 307.

In another example scenario, a “de-sensing” operation may be carried out based on detecting the ADC 325 going out of range (going into a saturation condition). The saturation condition may occur on the digital output of the ADC 325 when the signal amplitude of the analog signal input into the ADC 325 increases due to the wireless interference signal 308 being present inside one or more GNSS frequency bands of the GNSS signal 307 that is being used by the GNSS receiver 300 for position determination 345.

At least some of the signal amplitude drops detected in the GNSS receiver 300 may be attributable to signals that are not necessarily overlapping GNSS bands used by the GNSS receiver 300. For example, some of the signal amplitude variations can occur due to broadband radio-frequency interference (RFI) and/or due to jamming signals transmitted by jammers. RFI and jamming signals can cause interference in some of the components without necessarily traveling through the antenna 306 and without being affected by the bandpass filter 310. Consequently, in accordance with the disclosure, the controller 335 may perform interference mitigation 340 based on qualifying the detection of signal amplitude changes with additional information.

More particularly, the controller 335 may perform interference mitigation 340 based on additional information that indicates a time window when the interference can be expected to occur. Such information may be provided by one or more wireless transmitters such as, for example, the wireless transmitter 120 shown in FIG. 1. The information from the wireless transmitter may be conveyed to the controller 335 via a communication link 354 (such as, for example, the bus 119 shown in FIG. 2). In an example implementation, the timing information may be provided to the controller 335 in real time in the form of digital signals. The digital signals can be provided in the form of digital pulses having a duty cycle that is based on a time window when signal interference can be expected to occur. In an example embodiment, a pulse duration of a digital pulse can correspond to a duration of transmission of the wireless signal. The controller 335 may perform interference mitigation 340 during a portion of the pulse duration of the digital pulse in one example implementation and during an entirety of the pulse duration of the digital pulse in another example implementation.

In an example embodiment, the wireless transmitter can be a wireless wide-area network (WWAN) transmitter. A WWAN often differs from a wireless local area network (WLAN) by using mobile telecommunication cellular network technologies such as 2G, 3G, 4G LTE, and 5G to transfer data. In this case, the transmit timing information provided by the WWAN transmitter to the controller 335 can conform to one or more of the mobile telecommunication cellular network technologies associated with the WWAN transmitter.

In another example embodiment, the wireless transmitter can be an ultra-wideband (UWB) transmitter. UWB is a radio technology that uses low energy levels for short-range, high-bandwidth communications over a large portion of the radio spectrum. In this embodiment, the transmit timing information provided by the UWB transmitter can conform to a UWB transmission standard.

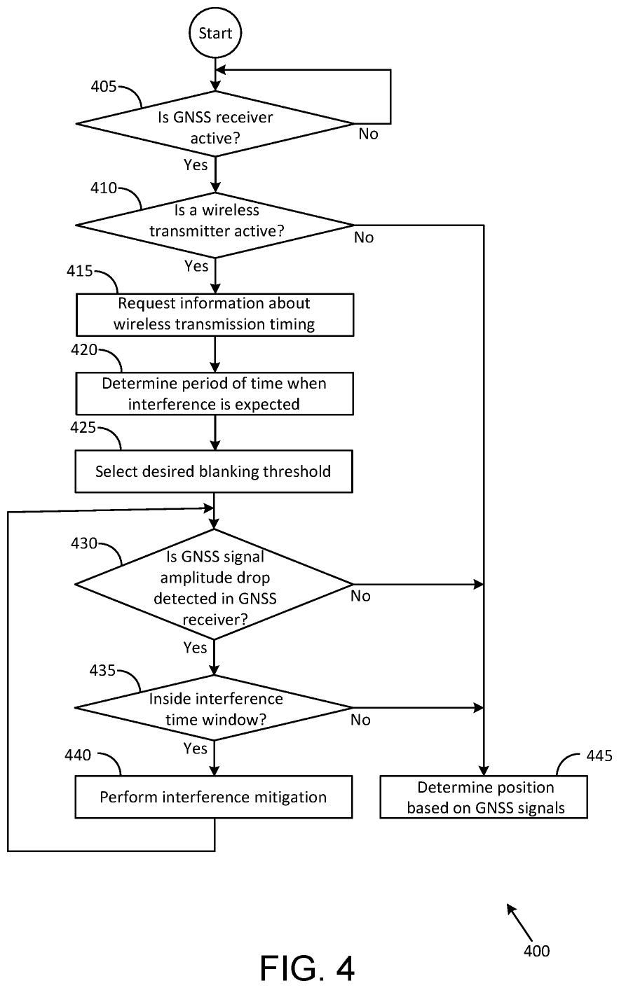

FIG. 4 shows a functional flow 400 of operations for mitigating wireless signal interference in a user equipment in accordance with an embodiment of the disclosure. The description below may refer to some components and functions described above, in the form of examples. However, it must be understood that the description is equally applicable to mitigating wireless signal interference in any user equipment containing components that can perform such operations.

Means for performing the functionality illustrated in one or more of the blocks shown in FIG. 4 may be performed by hardware and/or software components of a user equipment such as, for example, a smartphone. In some examples, the user equipment may perform the functionality illustrated in one or more of the blocks shown in FIG. 4 in an operating environment such as illustrated by the system 100 shown in FIG. 1 and described above. Example components of a user equipment are illustrated in FIG. 2, which is described above.

At block 405, the functionality can include making a determination whether a GNSS receiver is active. For example, with reference to the system 100 shown in FIG. 1, a determination may be made by a controller of the user equipment 125 whether the GNSS receiver 115 is active. If the GNSS receiver is not active, the functionality indicated in block 405 is repeated.

If the GNSS receiver is active, at block 410, a determination may be made whether a wireless transmitter is active. For example, with reference to the system 100 shown in FIG. 1, a determination may be made by a controller of the user equipment 125 whether the wireless transmitter 120 is active. The wireless transmitter can be any wireless transmitter that is identified as capable of transmitting signals having one or more frequency components that fall inside one or more GNSS bands used by the GNSS receiver 115 for performing satellite-based position determination operations. It is feasible that such frequency components can cause interference in the position determination operations.

If the wireless transmitter is not active, at block 445, the GNSS receiver may start or resume performing a position determination operation. In this case, an interference mitigation procedure may be deemed unnecessary and is not carried out.

If the wireless transmitter is active, at block 415, a request is made for timing information associated with wireless signal transmission by the wireless transmitter. The timing information may be provided in any one or more of various forms such as, for example, in the form of a pulse and/or in the form of a message. In an example implementation, a duration of the pulse can correspond to a duration of transmission of a wireless signal by the wireless transmitter. In an example implementation, it is known beforehand that the wireless signal includes frequency components that can cause interference in the position determination operations of the GNSS receiver.

At block 420, a determination can be made about a time window when interference can be expected to occur due to the wireless signal transmitted by the wireless transmitter. In an example implementation, the time window when interference can be expected to occur can be determined based on a duration of a pulse provided by the wireless transmitter as a part of the timing information described above with reference to block 415. In another example implementation, the time window when interference can be expected to occur can be determined based on information received from the wireless transmitter in the form of details pertaining to usage of a wireless standard by the wireless transmitter. For example, the wireless transmitter may be operating based on a wireless standard such as, for example, LTE wireless standard, 4G wireless standard, or 5G wireless standard, and the information provided to the GNSS receiver (via a message, for example) may include an identification of resource elements and/or resource blocks assigned to, and/or used by, the wireless transmitter. As is known, a resource element is the smallest unit of a resource grid and is made up of one subcarrier in the frequency domain and one OFDM symbol in the time domain. A resource group may be generally defined as a number of consecutive subcarriers in the frequency domain.

At block 425, a desired GNSS signal drop detection threshold may be set for detecting interference of the position determination operations of the GNSS receiver due to the operation of the wireless transmitter. Additional details pertaining to GNSS signal drop detection thresholds are described below using other figures.

At block 430, a determination may be made whether a drop in amplitude of a GNSS signal is detected in the GNSS receiver. In an example implementation, the drop in amplitude may be detected by the controller 335 described above with reference to FIG. 3. More particularly, the controller 335 can be configured to monitor components such as, for example, the front-end receiver 305, the gain amplifier 320, and the ADC 325 of the GNSS receiver 300 and detect amplitude variations that are attributable to wireless signals transmitted by the wireless transmitter.

If no drop in amplitude of a GNSS signal is detected by the GNSS receiver, at block 445, the GNSS receiver may start or resume performing a position determination operation. In this case, an interference mitigation procedure may be deemed unnecessary and is not carried out.

If a drop in amplitude of a GNSS signal is detected in the GNSS receiver, at block 435, a determination is made whether the drop in amplitude is occurring inside the time window when interference can be expected to occur. The time window is described above with reference to block 420.

If the drop in amplitude of the GNSS signal is detected to be occurring at a time other than inside the time window when signal interference can be expected to occur, at block 445, the GNSS receiver may perform position determination operations. In this case, an interference mitigation procedure may be deemed unnecessary and is not carried out. In this scenario, the drop in amplitude of the GNSS signal outside the time window may be due to other reasons such as, for example, due to an automatic gain control action in the GNSS receiver as a result of a fluctuation in signal strength of a GNSS signal. The fluctuation in signal strength of the GNSS signal may occur due to various reasons including, for example, due to satellite signal reflection from objects.

If the drop in amplitude of the GNSS signal is detected to be occurring inside the time window when signal interference can be expected to occur, at block 440 an interference mitigation procedure is performed. The interference mitigation procedure can be implemented in various ways. In an example implementation, position information determined during the drop in signal amplitude of the GNSS signal below the signal drop detection threshold may be discarded and not used for position determination. Discarding position information may be referred to as “blanking” of the GNSS signal when the interference is taking place.

In another example implementation, interference mitigation may be carried out by performing position determination based on switching from a first GNSS signal to an alternative GNSS signal. The first GNSS signal may be identified based on its susceptibility to interference from the wireless signal over the period of time during which the drop in signal amplitude is expected. Use of the first GNSS signal may be suspended after identifying a suitable alternative GNSS signal. The alternative GNSS signal may, for example, be received from a GNSS space vehicle other than the GNSS space vehicle that is providing the satellite signal that is undergoing interference. The GNSS receiver may select the alternative GNSS space vehicle based on determining that the GNSS band of operation of the alternative GNSS space vehicle is either not impacted by, or is less impacted by, signal interference from the wireless transmitter. The GNSS receiver may further select the alternative GNSS vehicle based on signal characteristics such as, for example, a higher signal-to-noise ratio (SNR). An example method to perform interference mitigation in this manner can include identifying at least a first GNSS signal among one or more GNSS signals that is susceptible to interference from the wireless signal during the time window described above. Use of the first GNSS signal for performing the position determination operation may be stopped momentarily for a portion of, or an entirety of the duration of the time window and resumed outside the time window.

In another example implementation, the GNSS receiver may be configured to communicate with the wireless transmitter for mitigating interference based on modifying a mode of operation of the wireless transmitter. The communication may be carried out, for example, by the GNS receiver issuing a command or an advisory to the wireless transmitter. Such a command or advisory may define power levels, frequencies, and/or time periods during which the wireless transmitter can transmit wireless signals that can interfere with GNSS signals used by the GNSS receiver.

In some embodiments, an application or high level operating system (HLOS) of the user equipment in which the GNSS receiver and the wireless transmitter are co-located, may provide an indication as to whether a location determination operation performed by the GNSS receiver should be given priority. If the GNSS receiver has priority, the wireless transmitter may be required to abide by the command/advisory received from the GNSS receiver. If the wireless transmitter has priority, the wireless transmitter may opt to ignore the command/advisory issued by the GNSS receiver.

The operations described above with reference to block 430, block 435, and block 440 may be performed in an iterative manner until a determination is made at block 430 that a drop in signal amplitude of the GNSS signal is no longer taking place or at block 435 that a drop in signal amplitude of the GNSS signal is not attributable to the wireless signal transmitted by the wireless transmitter. If the drop in signal amplitude of the GNSS signal is no longer taking place or the drop in signal amplitude of the GNSS signal is not attributable to the wireless signal transmitted by the wireless transmitter, at block 445, the GNSS receiver may start or resume performing a position determination operation. In this case, an interference mitigation procedure may be deemed unnecessary and is not carried out.

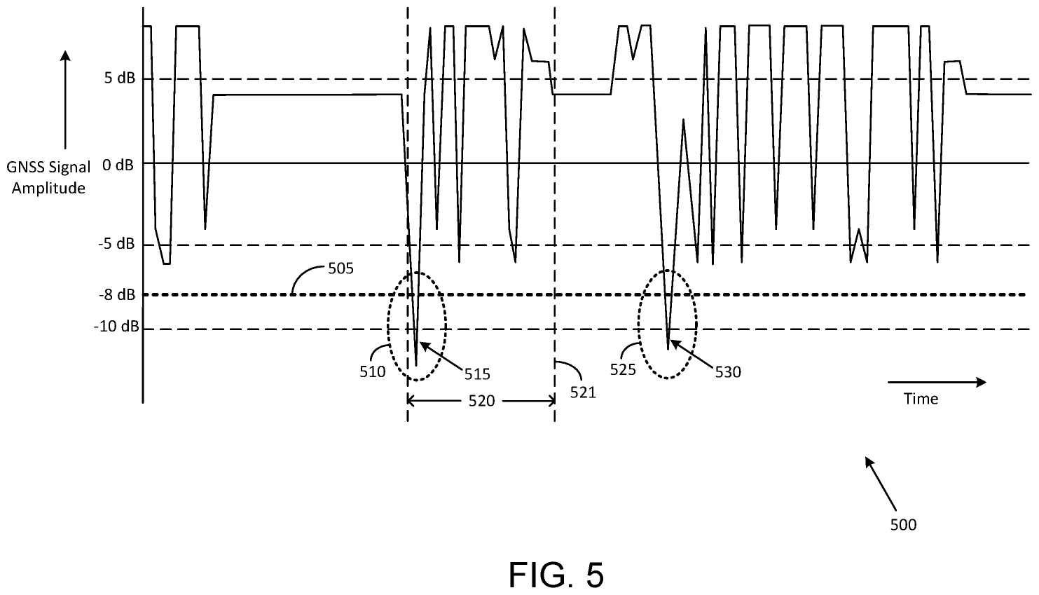

FIG. 5 illustrates a first graphical representation 500 for describing an example operation to detect a drop in GNSS signal amplitude in the presence of wireless signal interference in accordance with an embodiment. The graphical representation 500 provides an indication of example GNSS signal amplitude variations over time. The GNSS signal amplitude variations may be observed at any of various locations in a GNSS receiver such as, for example, on an output terminal of a signal amplifier in the front-end receiver 305 shown in FIG. 3 or an output terminal of the gain amplifier 320 shown in FIG. 3. The description below pertains to block 425 of the functional flow 400 of operations described above. Block 425 indicates an action associated with setting a desired GNSS signal drop detection threshold for detecting interference of the position determination operations of the GNSS receiver due to the operation of the wireless transmitter.

A first GNSS signal drop detection threshold 505 that is illustrated in FIG. 5 as a first example, corresponds to an 8 dB drop in amplitude with respect to a nominal 0 reference amplitude level. The first GNSS signal drop detection threshold 505 may be set by any of various entities in various implementations such as, for example, a manufacturer of the user equipment 125 shown in FIG. 1, a user of the user equipment 125, or a vendor of the user equipment 125.

Time window 520 corresponds to a period of time during which the GNSS receiver 115 is vulnerable to signal interference that is attributable to a wireless signal transmitted by the wireless transmitter 120. The signal interference may occur when one or more GNSS signals are being used by the GNSS receiver 115 for determining a position of the user equipment 125. The time window 520 may be communicated to the GNSS receiver 115 by the wireless transmitter 120 via the bus 119, for example.

In the illustrated example scenario, the GNSS signal amplitude drops below the first GNSS signal drop detection threshold 505 at one moment in time, which is indicated by a GNSS signal amplitude drop 515 highlighted by a dashed line marking 510. The GNSS signal amplitude drop 515 may be detected by applying the first GNSS signal drop detection threshold 505 when monitoring one or more components of the GNSS receiver 115. The controller 335 may perform the monitoring and detection operations as described above.

In an example implementation, an interference mitigation operation can be started upon detection of the GNSS signal amplitude drop 515. The interference mitigation operation can extend over a period of time that spans the remaining portion of the time window 520 until the end point 521. Other GNSS signal amplitude drops below the first GNSS signal drop detection threshold 505 may occur during this period of time and can be disregarded because the interference mitigation operation is being performed until the end point 521.

In another example implementation, an interference mitigation operation can be started upon detection of the GNSS signal amplitude drop 515 and can extend over a shorter period of time during the remaining portion of the time window 520 rather than extending all the way until the end point 521. In this case, one or more interference mitigation operations can be performed based on detecting one or more GNSS signal amplitude drops below the first GNSS signal drop detection threshold 505 until the end point 521.

The example graphical representation 500 further illustrates a GNSS signal amplitude drop 530 occurring outside the time window 520. The GNSS signal amplitude drop 530, which is highlighted by a dashed line marking 525, is attributable to causes other than wireless signals transmitted by the wireless transmitter 120. For example, the GNSS signal amplitude drop 530 is attributable to causes other than wireless signals transmitted by the wireless transmitter 120 because the wireless transmitter 120 is in an inactive state when the GNSS signal amplitude drop 530 occurs. Interference mitigation procedures, if taken, can be different than the interference mitigation procedures described herein with respect to GNSS signal amplitude drops occurring inside the time window 520.

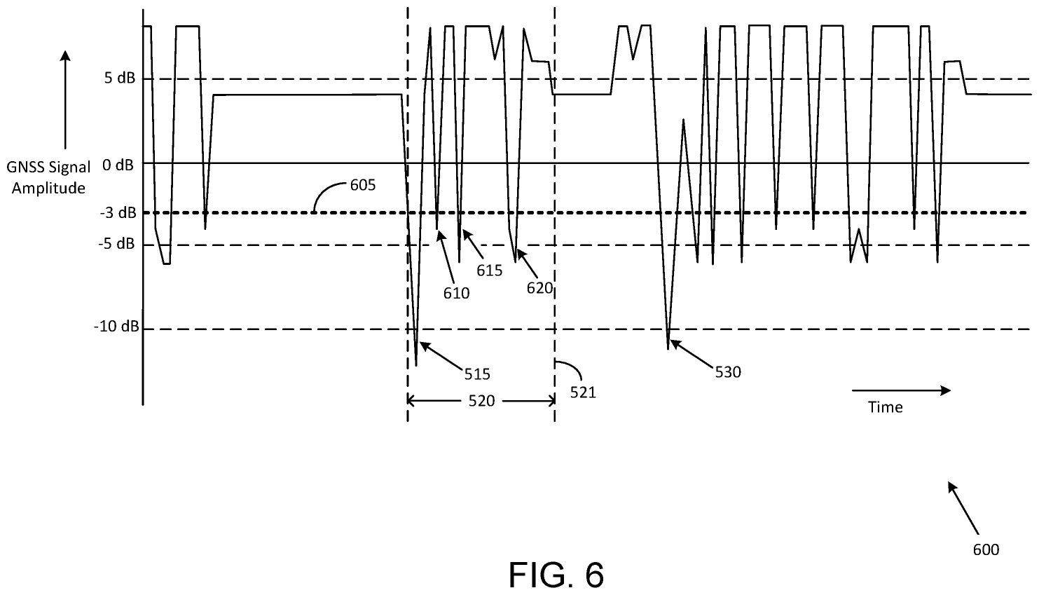

FIG. 6 illustrates a second graphical representation 600 for describing an example operation to detect a drop in GNSS signal amplitude in the presence of wireless signal interference in accordance with an embodiment. The second graphical representation 600 is identical to the first graphical representation 500 described above with respect to the axes, the waveform, and the time window 520. However, in contrast to the first GNSS signal drop detection threshold 505 that is illustrated in FIG. 5 (corresponding to an 8 dB drop in amplitude with respect to a nominal 0 reference amplitude level), the second graphical representation 600 illustrates an example second GNSS signal drop detection threshold 605 corresponding to a 3 dB drop in amplitude with respect to the nominal 0 reference amplitude level.

In the illustrated example scenario, the GNSS signal amplitude drops below the second GNSS signal drop detection threshold 605 at multiple instances inside the time window 520 such as, for example, a first GNSS signal amplitude drop 515 (described above with reference to FIG. 5), a second GNSS signal amplitude drop 610, a third GNSS signal amplitude drop 615, and a fourth GNSS signal amplitude drop 620. The multiple GNSS signal amplitude drops may be detected by applying the second GNSS signal drop detection threshold 605 when monitoring one or more components of the GNSS receiver 115 (as described above). Interference mitigation procedures may be performed in response to the multiple detections. Here again, the GNSS signal amplitude drop 525 occurs outside the time window 520 and can be attributed to causes other than wireless signals transmitted by the wireless transmitter 120.

In an example implementation, an interference mitigation operation can be started upon detection of the GNSS signal amplitude drop 515 and can extend over a period of time that spans the remaining portion of the time window 520. In another example implementation, an interference mitigation operation can be started upon detection of each of the GNSS signal amplitude drops and can extend over shorter periods of time during the remaining portion of the time window 520. Thus, for example, a first interference mitigation operation can be started upon detection of the GNSS signal amplitude drop 515 and terminated before detection of the second GNSS signal amplitude drop 610. A second interference mitigation operation can be started upon detection of the GNSS signal amplitude drop 610 and terminate before detection of the third GNSS signal amplitude drop 615. A third interference mitigation operation can be started upon detection of the GNSS signal amplitude drop 615 and terminate before detection of the third GNSS signal amplitude drop 620. A fourth interference mitigation operation can be started upon detection of the GNSS signal amplitude drop 620 and terminate at, or before, the end point 521 of the time window 520.

The description provided above with reference to the first GNSS signal drop detection threshold 505 and the second GNSS signal drop detection threshold 605 illustrates a relationship between a setting of a GNSS signal amplitude drop threshold and the number of times when GNSS signal amplitude drops are detected. The number of times when interference mitigation procedures are carried out can correspond to the number of times when GNSS signal amplitude drops are detected.

Thus, for example, a first number of times when interference mitigation actions are taken based on a first signal drop detection threshold can be different than a second number of times when interference mitigation actions are taken based on a second signal drop detection threshold. The first number of times can be lower than the second number of times when the first signal drop detection threshold is set at a greater level than the second signal drop detection threshold. The first number of times can reflect a first level of mitigation efficiency and the second number of times can reflect a second level of mitigation efficiency.

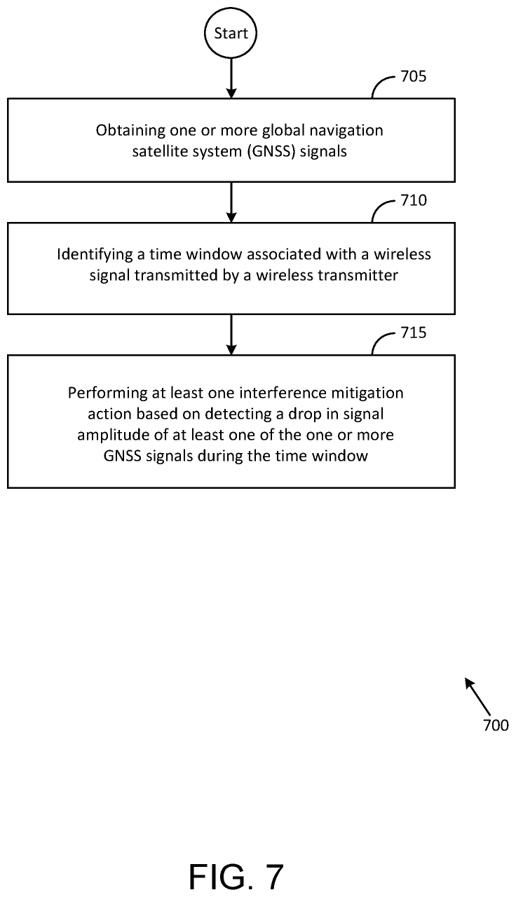

FIG. 7 shows a flowchart 700 of a method to mitigate wireless signal interference in a position determination operation in accordance with an embodiment of the disclosure. Means for performing the functionality illustrated in one or more of the blocks shown in FIG. 7 may be performed by hardware and/or software components of a user equipment such as, for example, a smartphone. In some examples, the user equipment may perform the functionality illustrated in one or more of the blocks shown in FIG. 7 in an operating environment such as illustrated by the system 100 shown in FIG. 1 and described above. Example components of a user equipment are illustrated in FIG. 2, which is described above.

At block 705, the functionality can include obtaining one or more GNSS signals. In an example scenario that is illustrated in FIG. 1, one or more GNSS signals may be obtained from one, or both, of the GNSS satellite vehicle 105 and the GNSS satellite vehicle 110. In an example embodiment, one or more GNSS signals may be obtained via a GNSS receiver of a user equipment (such as, for example, the GNSS receiver 115 of the user equipment 125).

At block 710, the functionality can include identifying a time window associated with a wireless signal transmitted by a wireless transmitter. In an example embodiment, the time window may be identified based on information about the wireless signal that can be obtained from a wireless transmitter. In one case, the information about the wireless signal can be contained in one or more messages and/or one or more digital signals. The digital signals can include at least one digital signal having a pulse duration that corresponds to a duration of transmission of the wireless signal. A description of such a functionality is described above with reference to FIG. 3, wherein information from a wireless transmitter (such as the wireless transmitter 120 shown in FIG. 1), can be conveyed to the controller 335 in the GNSS receiver 300, via the communication link 354.

At block 715, the functionality can include performing at least one interference mitigation action based on detecting a drop in signal amplitude of at least one of the one or more GNSS signals during the time window. In an example scenario, the drop in signal amplitude of the GNSS signal(s) during the time window may be detected based on monitoring a signal amplitude in a component of a GNSS receiver. The component where the signal amplitude is monitored can be, for example, an amplifier configured to amplify the GNSS signal(s), or an analog-to-digital converter (ADC). Monitoring the ADC can include detecting an out-of-conversion-range condition in the ADC.

In an example implementation, detecting the drop in signal amplitude of the GNSS signal(s) in a GNSS receiver during the time window can include determining whether the wireless transmitter is in a standby state or an inactive state. If the wireless transmitter is in a standby state or an inactive state, a first signal amplitude at a terminal of at least one component in a GNSS receiver(s) may be detected. If the wireless transmitter is then determined to be in an active state, a second signal amplitude at the terminal of the component may be detected. A determination may then be made whether a margin of difference between the second signal amplitude and the first signal amplitude exceeds a threshold margin. Signal drop detection threshold 505 and signal drop detection threshold 605 are two example threshold margins described above.

The signal drop detection threshold 505 and signal drop detection threshold 605 illustrate a relationship between a setting of a GNSS signal amplitude drop threshold and the number of times when GNSS signal amplitude drops are detected. The number of times when interference mitigation procedures are carried out can correspond to the number of times when GNSS signal amplitude drops are detected. Thus, for example, a first number of times when interference mitigation actions are taken based on a first signal drop detection threshold can be different than a second number of times when interference mitigation actions are taken based on a second signal drop detection threshold. The first number of times can be lower than the second number of times when the first signal drop detection threshold is set at a greater level than the second signal drop detection threshold. The first number of times can reflect a first level of mitigation efficiency and the second number of times can reflect a second level of mitigation efficiency. Thus, in an example implementation, the threshold signal amplitude is settable based a desired level of interference mitigation, and more particularly, based on detecting a rate of occurrence of the signal amplitude dropping below the threshold signal amplitude and/or a number of occurrences of the signal amplitude dropping below the threshold signal amplitude.

At block 720, the functionality can include performing at least one interference mitigation action based on detecting the drop in signal amplitude. In an example implementation, performing an interference mitigation action can include identifying a GNSS signal that is susceptible to interference from the wireless signal over the time window during which the drop in signal amplitude of the GNSS signal is expected. The interference mitigation action can further include suspending use of the GNSS signal for performing the position determination operation during at least the time window during which the drop in signal amplitude of the GNSS signal is expected. In an example implementation, an interference mitigation action may be stopped based on the signal amplitude staying above the threshold signal amplitude during one or more other periods of time over the pulse duration.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1 A method to mitigate interference in a position determination operation can include obtaining one or more global navigation satellite system (GNSS) signals; identifying a time window associated with a wireless signal transmitted by a wireless transmitter; and performing at least one interference mitigation action based on detecting a drop in signal amplitude of at least one of the one or more GNSS signals during the time window.

Clause 2 The method of clause 1, wherein identifying the time window is based, at least in part, on expecting the drop in signal amplitude to occur during the time window due to interference from the wireless signal.

Clause 3 The method of any of clauses 1 or 2, wherein performing the at least one interference mitigation action can include identifying at least a first GNSS signal among the one or more GNSS signals that is susceptible to interference from the wireless signal over the time window during which the drop in signal amplitude of the at least one of the one or more GNSS signals is expected; and performing the position determination operation based on at least one of a subset of GNSS signals that precludes the first GNSS signal.

Clause 4 The method of any of clauses 1 through 3, wherein identifying the time window during which the drop in signal amplitude is expected to occur can include obtaining information about the wireless signal from the wireless transmitter; and determining the time window during which the drop in signal amplitude is expected to occur, based on at least the information about the wireless signal obtained from the wireless transmitter.

Clause 5 The method of clause 4, wherein the information about the wireless signal is contained in at least one of one or more messages or one or more digital signals.

Clause 6 The method of clause 5, wherein the one or more digital signals comprise at least one digital signal having a pulse duration that corresponds to a duration of transmission of the wireless signal.

Clause 7 The method of clause 6, wherein detecting the drop in signal amplitude of the at least one of the one or more GNSS signals can include monitoring a signal amplitude at a terminal of at least one component in at least one of one or more GNSS receivers, the monitoring extending over the pulse duration of the at least one digital signal; and detecting a drop in the signal amplitude below a threshold signal amplitude during one or more periods of time over the pulse duration of the at least one digital signal.

Clause 8 The method of clause 7, further comprising stopping the at least one interference mitigation action based on the signal amplitude staying above the threshold signal amplitude during one or more other periods of time over the pulse duration of the at least one digital signal.

Clause 9 The method of any of clauses 7 or 8, wherein the threshold signal amplitude is settable based on at least one of detecting a rate of occurrence of the signal amplitude dropping below the threshold signal amplitude, detecting a number of occurrences of the signal amplitude dropping below the threshold signal amplitude, or a desired level of interference mitigation.

Clause 10 The method of any of clauses 7 through 9, wherein the at least one component is an amplifier configured to amplify the at least one of the one or more GNSS signals.

Clause 11 The method of any of clauses 1 through 9, wherein detecting the drop in signal amplitude of the at least one of the one or more GNSS signals comprises monitoring at least one analog-to-digital converter (ADC) in a GNSS receiver to detect an out-of-conversion-range condition.

Clause 12 The method of any of clauses 1 through 9, wherein detecting the drop in signal amplitude of the at least one of the one or more GNSS signals comprises determining that the wireless transmitter is in one of a standby state or an inactive state; detecting, upon determining that the wireless transmitter is in the one of the standby state or the inactive state, a first signal amplitude at a terminal of at least one component in at least one of one or more GNSS receivers; determining that the wireless transmitter is in an active state; detecting, upon determining that the wireless transmitter is in the active state, a second signal amplitude at the terminal of the at least one component in the at least one of one or more GNSS receivers; and determining that a margin of difference between the second signal amplitude and the first signal amplitude exceeds a threshold margin.

Clause 13 The method of any of clauses 1 through 12, wherein the wireless transmitter is included in one of a wireless wide area network (WWAN) system, an ultra-wideband (UWB) system, a radio-frequency sniffer system, a Wi-Fi system, a Bluetooth system, a near-field communications (NFC) system, or a combination thereof.

Clause 14 The method of any of clauses 1 through 13, wherein the wireless signal comprises at least one frequency that is included in at least one of one or more L-bands of operation of one or more GNSS systems.

Clause 15 A device that performs a position determination operation with interference mitigation, comprising at least one memory and one or more processors communicatively coupled with the at least one memory, the one or more processors configured to obtain one or more GNSS signals; identify a time window associated with a wireless signal transmitted by a wireless transmitter; and perform at least one interference mitigation action based on detecting a drop in signal amplitude of at least one of the one or more GNSS signals during the time window.

Clause 16 The device of clause 15, wherein identifying the time window is based, at least in part, on expecting the drop in signal amplitude to occur during the time window due to interference from the wireless signal.

Clause 17 The device of any of clauses 15 or 16, wherein to perform the at least one interference mitigation action, the one or more processors are configured to identify at least a first GNSS signal among the one or more GNSS signals that is susceptible to interference from the wireless signal over the time window during which the drop in signal amplitude of the at least one of the one or more GNSS signals is expected; and perform the position determination operation based on at least one of a subset of GNSS signals that precludes the first GNSS signal.

Clause 18 The device of any of clauses 15 through 17, wherein to identify the time window, the one or more processors are configured to obtain information about the wireless signal from the wireless transmitter; and determine the time window during which the drop in signal amplitude is expected to occur, based on at least the information about the wireless signal obtained from the wireless transmitter.

Clause 19 The device of any of clauses 15 through 18, wherein the information about the wireless signal is contained in at least one of one or more messages or one or more digital signals, the one or more digital signals including at least one digital signal having a pulse duration that corresponds to a duration of transmission of the wireless signal.

Clause 20 The device of clause 19, wherein to detect the drop in signal amplitude of the at least one of the one or more GNSS signals, the one or more processors are configured to monitor a signal amplitude at a terminal of at least one component in at least one of one or more GNSS receivers, the monitoring extending over the pulse duration of the at least one digital signal; and detect a drop in the signal amplitude below a threshold signal amplitude during one or more periods of time over the pulse duration of the at least one digital signal.

Clause 21 An apparatus having means for performing the method of any one of clauses 1-14.

Clause 22 A non-transitory computer-readable medium storing instructions, the instructions comprising code for performing the method of any one of clauses 1-14.

What is claimed is:

1. A method to mitigate interference in a position determination operation, the method comprising:
obtaining one or more global navigation satellite system (GNSS) signals;
identifying a time window associated with a wireless signal transmitted by a wireless transmitter; and
performing at least one interference mitigation action based on detecting a drop in signal amplitude of at least one of the one or more GNSS signals during the time window.

2. The method of claim 1, wherein identifying the time window is based, at least in part, on expecting the drop in signal amplitude to occur during the time window due to interference from the wireless signal.

3. The method of claim 2, wherein performing the at least one interference mitigation action comprises:
identifying at least a first GNSS signal among the one or more GNSS signals that is susceptible to interference from the wireless signal over the time window during which the drop in signal amplitude of the at least one of the one or more GNSS signals is expected; and
performing the position determination operation based on at least one of a subset of GNSS signals that precludes the first GNSS signal.

4. The method of claim 3, wherein identifying the time window during which the drop in signal amplitude is expected to occur comprises:
obtaining information about the wireless signal from the wireless transmitter; and
determining the time window during which the drop in signal amplitude is expected to occur, based on at least the information about the wireless signal obtained from the wireless transmitter.

5. The method of claim 4, wherein the information about the wireless signal is contained in at least one of one or more messages or one or more digital signals.

6. The method of claim 5, wherein the one or more digital signals comprise at least one digital signal having a pulse duration that corresponds to a duration of transmission of the wireless signal.

7. The method of claim 6, wherein detecting the drop in signal amplitude of the at least one of the one or more GNSS signals comprises:
monitoring a signal amplitude at a terminal of at least one component in at least one of one or more GNSS receivers, the monitoring extending over the pulse duration of the at least one digital signal; and
detecting a drop in the signal amplitude below a threshold signal amplitude during one or more periods of time over the pulse duration of the at least one digital signal.

8. The method of claim 7, further comprising:
stopping the at least one interference mitigation action based on the signal amplitude staying above the threshold signal amplitude during one or more other periods of time over the pulse duration of the at least one digital signal.

9. The method of claim 8, wherein the threshold signal amplitude is settable based on at least one of detecting a rate of occurrence of the signal amplitude dropping below the threshold signal amplitude, detecting a number of occurrences of the signal amplitude dropping below the threshold signal amplitude, or a desired level of interference mitigation.

10. The method of claim 8, wherein the at least one component is an amplifier configured to amplify the at least one of the one or more GNSS signals.

11. The method of claim 8, wherein detecting the drop in signal amplitude of the at least one of the one or more GNSS signals comprises:
monitoring at least one analog-to-digital converter (ADC) in a GNSS receiver to detect an out-of-conversion-range condition.

12. The method of claim 6, wherein detecting the drop in signal amplitude of the at least one of the one or more GNSS signals comprises:
determining that the wireless transmitter is in one of a standby state or an inactive state;
detecting, upon determining that the wireless transmitter is in the one of the standby state or the inactive state, a first signal amplitude at a terminal of at least one component in at least one of one or more GNSS receivers;
determining that the wireless transmitter is in an active state;
detecting, upon determining that the wireless transmitter is in the active state, a second signal amplitude at the terminal of the at least one component in the at least one of one or more GNSS receivers; and
determining that a margin of difference between the second signal amplitude and the first signal amplitude exceeds a threshold margin.

13. The method of claim 1, wherein the wireless transmitter is included in one of a wireless wide area network (WWAN) system, an ultra-wideband (UWB) system, a radio-frequency sniffer system, a Wi-Fi system, a Bluetooth system, a near-field communications (NFC) system, or a combination thereof.

14. The method of claim 1, wherein the wireless signal comprises at least one frequency that is included in at least one of one or more L-bands of operation of one or more GNSS systems.

15. A device that performs a position determination operation with interference mitigation, comprising:
at least one memory; and
one or more processors communicatively coupled with the at least one memory, the one or more processors configured to:
obtain one or more GNSS signals;
identify a time window associated with a wireless signal transmitted by a wireless transmitter; and
perform at least one interference mitigation action based on detecting a drop in signal amplitude of at least one of the one or more GNSS signals during the time window.

16. The device of claim 15, wherein identifying the time window is based, at least in part, on expecting the drop in signal amplitude to occur during the time window due to interference from the wireless signal.

17. The device of claim 15, wherein to perform the at least one interference mitigation action, the one or more processors are configured to:
identify at least a first GNSS signal among the one or more GNSS signals that is susceptible to interference from the wireless signal over the time window during which the drop in signal amplitude of the at least one of the one or more GNSS signals is expected; and
perform the position determination operation based on at least one of a subset of GNSS signals that precludes the first GNSS signal.

18. The device of claim 16, wherein to identify the time window, the one or more processors are configured to:
obtain information about the wireless signal from the wireless transmitter; and
determine the time window during which the drop in signal amplitude is expected to occur, based on at least the information about the wireless signal obtained from the wireless transmitter.

19. The device of claim 18, wherein the information about the wireless signal is contained in at least one of one or more messages or one or more digital signals, the one or more digital signals including at least one digital signal having a pulse duration that corresponds to a duration of transmission of the wireless signal.

20. The device of claim 19, wherein to detect the drop in signal amplitude of the at least one of the one or more GNSS signals, the one or more processors are configured to:
monitor a signal amplitude at a terminal of at least one component in at least one of one or more GNSS receivers, the monitoring extending over the pulse duration of the at least one digital signal; and
detect a drop in the signal amplitude below a threshold signal amplitude during one or more periods of time over the pulse duration of the at least one digital signal.
